(19) United States
(12) Patent Application Publication
(10) Pub. No.: US 2006/0230039 A1
(43) Pub. Date: Oct. 12, 2006

(54) Online identity tracking

(75) Inventors: Mark Shull, Chevy Chase, MD (US); William Bohlman, Boise, ID (US); Elisa Cooper, Boise, ID (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: MarkMonitor, Inc., Boise, ID (US)

(21) Appl. No.: 11/339,985

(22) Filed: Jan. 25, 2006

Related U.S. Application Data
(60) Provisional application No. 60/647,109, filed on Jan. 25, 2005.
(60) Provisional application No. 60/658,124, filed on Mar. 2, 2005.
(60) Provisional application No. 60/658,087, filed on Mar. 2, 2005.
(60) Provisional application No. 60/658,281, filed on Mar. 2, 2005.

(51) Int. Cl. G06F 17/30

(52) U.S. Cl. 707/6

(57) ABSTRACT

Embodiments of the invention provide novel systems, software and methods for gathering information about online entities and for identifying, evaluating and scoring such entities. Merely by way of example, the trustworthiness of an online entity, such as a domain, can be evaluated based information known about other online entities (e.g., the owner of the domain, other domains) associated with that domain. In an aspect of the invention, for example, publicly-available data (and, in some cases, other data) can be obtained and correlated to reveal previously-unknown associations between various online entities, despite, in some cases, the attempts of those entities to obscure such associations. This can facilitate the evaluation of such entities. For instance, if a new domain is registered, there generally is little basis on which to evaluate the trustworthiness of that domain (other than facially-apparent characteristics, such as the domain name itself), since it has not yet begun operating. By ascertaining the domain's association with other online entities, however, information known about the reputation and/or behavior of those entities can be used to inform an evaluation of the domain.

### CROSS-REFERENCE TO RELATED APPLICATIONS

This application is a non-provisional of, and claims the benefit, of provisional U.S. Pat. App. No. 60/647,109, filed Jan. 25, 2005 by Shull et al. and entitled “Online Identity Tracking,” the entire disclosure of which is hereby incorporated herein by reference. This application also claims the benefit of the following applications, of which the entire disclosure of each is incorporated herein by reference, and which are referred to herein collectively as the “Trust Database Applications”: provisional U.S. Pat. App. No. 60/658,124, entitled “Distribution of Trust Data,” and filed on Mar. 3, 2005 by Shull et al.; provisional U.S. Pat. App. No. 60/658,087, entitled “Trust Evaluation System and Methods,” and filed on Mar. 3, 2005 by Shull et al.; and provisional U.S. Pat. App. No. 60/658,281, entitled “Implementing Trust Policies,” and filed on Mar. 3, 2005 by Shull et al.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

As ever more business is transacted online, the ability to identify online entities becomes increasingly important. For example, if a user desires to transact business online with a particular entity, the user generally would like to be able to determine with a high degree of confidence that the entity actually is who it purports to be. Various solutions have been proposed to provide some verifiable identification of entities, including without limitation the DomainKeys system proposed by Yahoo, Inc., the Sender Profile Form (“SPF”) system, and the CallerID for Email scheme proposed by Microsoft, Inc. These systems all attempt to provide identity authentication, for example, by guaranteeing that an IP address or domain name attempting to transmit the web page, email message or other data is the actual IP address or domain purporting to transmit the data, and not a spoofed IP address or domain name.

These solutions, however, fail to address a much larger issue: In many cases, the mere verification that a message originates from a particular domain provides little assurance if the user cannot verify the true identity of the owner domain itself or know the degree to which the IP address is likely to be secure and not compromised. For certain well-known domains, such as <microsoft.com>, the domain name itself may provide a relatively reliable identification of the entity operating the domain. For most domains and IP addresses, however, the domain name or source IP address cannot be considered, on its own, to provide reliable information on the trustworthiness of the underlying domain or IP address itself.

The well-known WHOIS protocol attempts to provide some identification of the entity owning a particular domain. Those skilled in the art will appreciate, however, that there is no authoritative or central WHOIS database that provides identification for every domain. Instead, various domain name registration entities (including without limitation registrars and registries) provide varying amounts of WHOIS registrant identity data, which means that there is no single, trusted or uniform source of domain name identity data. Moreover, many registrars and registries fail to follow any standard conventions for their WHOIS data structure, meaning that data from two different registrars or registries likely will be organized in different ways, making attempts to harmonize data from different databases difficult, to say the least. Further compounding the problem is that most WHOIS databases cannot be searched except by domain name, so that even if the owner of a given domain can be identified, it is difficult (if not impossible) to determine what other domains that owner owns, or even to determine whether the ownership information for a given domain is correct. Coupled with the reality that many domain owners provide mostly incorrect domain information, this renders the WHOIS protocol virtually useless as a tool for verifying the identity of a domain owner.

The concept of a “reverse WHOIS” process has been proposed as one solution to this issue. Reverse WHOIS, which provides more sophisticated data-collection and searching methods for WHOIS information, is described in further detail in the following commonly-owned, co-pending applications, each of which is hereby incorporated by reference, and which are referred to collectively herein as the “Reverse WHOIS Applications”: U.S. patent application Nos. 11/009,524, 11/009,529, 11/009,530, and 11/009,531 (all filed by Bura et al. on Dec. 10, 2004). The concept of reverse WHOIS, while addressing some of the problems in identifying the owner of a domain, still fails to provide a comprehensive solution for identifying an online entity.

Consider, for example, a situation in which an online fraud has been identified. Systems for identifying and responding to online fraud are described in detail in the following commonly-owned, co-pending applications, each of which is hereby incorporated by reference, and which are referred to collectively herein as the “Anti-Fraud Applications”: U.S. patent application No. 10/709,938 (filed by Shraim et al. on May 2, 2004); and U.S. patent application Nos. 10/996,566, 10/996,567, 10/996,568, 10/996,646, 10/996,990, 10/996,991, 10/996,993, and 10/997,626 (all filed by Shraim, Shull, et al. on Nov. 23, 2004). Once an online fraud has been identified, it would be helpful to be able to identify a perpetrator of that fraud. In many cases, however, the only identifying information available is an IP address of a server engaged in the online fraud. In this case, a reverse WHOIS search may be unhelpful, since WHOIS information generally does not pertain to IP addresses, but to domains.

Thus, a more robust solution for identifying online entities is needed.

### BRIEF SUMMARY OF THE INVENTION

Embodiments of the invention provide novel systems, software and methods for gathering information about online entities and for identifying, evaluating and scoring such entities. Merely by way of example, the trustworthiness of an online entity, such as a domain, can be evaluated based information known about other online entities (e.g., the owner of the domain, other domains) associated with that domain. In an aspect of the invention, for example, publicly-available data (and, in some cases, other data) can be obtained and correlated to reveal previously-unknown associations between various online entities, despite, in some cases, the attempts of those entities to obscure such associations. This can facilitate the evaluation of such entities. For instance, if a new domain is registered, there generally is little basis on which to evaluate the trustworthiness of that domain (other than facially-apparent characteristics, such as the domain name itself), since it has not yet begun operating. By ascertaining the domain's association with other online entities, however, information known about the reputation and/or behavior of those entities can be used to inform an evaluation of the domain.

Hence, certain embodiments of the invention provide the ability to gather, correlate, search and/or analyze identifying information about online entities. Merely by way of example, in accordance with some embodiments, a plurality of diverse data sets may be acquired. The data sets can include, without limitation, WHOIS data, network registration data, UDRP data, DNS record data, hostname data, zone file data, fraud-related data, corporate records data, trademark registration data, hosting provider data, ISP and online provider acceptable use policy (“AUP”) data, past security event data, case law data and/or other primary and/or derived data related to the registration, background, enabling services and actual monitored record of an entity on the Internet. The data sets may be processed and/or saved in a format to allow cross-indexing and/or cross-referencing between various types of data. In particular embodiments, the data sets may be searched based on a search term to identify correlated data from among the various data sets. In this way, for example, correlated data (which previously may not have appeared to have any relationship to the search term) may be discovered to comprise identifying information and thus may be used to identify an entity based on the search term. Further, this identifying information may also be used as additional search terms (for instance, to narrow and/or broaden an earlier search), and thus may produce additional identifying or relationship information.

One set of embodiments, for example, provides methods, including without limitation methods of gathering information about online entities and methods of evaluating online entities. An exemplary method of evaluating an online entity in accordance with certain embodiments comprises maintaining a database. The database might comprise a plurality of records corresponding to a plurality of online entities, record might comprise information about one of the online entities.

In some cases, the method further comprises identifying a domain registration of interest. The domain registration comprising a data element comprising information related to the domain of interest (such fields can include, without limitation, a physical address field, a registrant email address field, an administrative email address field, a telephone number field, a personal name, corporate name and/or the like). The method, then, might further comprise searching the database for the data element to produce a search result comprising a set of one or more records. One of the set of one or more records might corresponding to an online entity.

The domain might then be associated with the online entity (perhaps, for example, by creating a database record associating the domain with the online entity). In addition, in some embodiments, a second data element might be identified in the record corresponding to the online entity. Hence, the database can be searched for the second data element to produce a search result comprising a second set of one or more records, one of which might correspond to a second online entity. The domain registration might be associated with the second online entity as well. Further, in some embodiments, the method might comprise determining whether the domain registration is likely to be trustworthy, based perhaps upon information about the first and second online entities.

A method in accordance with another set of embodiments might be used to identify an online entity. The method, in some cases, comprises maintaining in a data store a set of data about a plurality of online entities. The set of data might comprise a plurality of data elements, each of which is related to at least one of the plurality of online entities. The method might further comprise identifying with a computer a first of the plurality of online entities, based on at least part of the set of data, and/or identifying a first data group, which might comprise at least one data element associated with a first of the plurality of online entities. A second data group might also be identified. The second data group might comprise at least one data element associated with a second of the plurality of online entities, perhaps be creating an association in the database.

In some embodiments, the method further comprises determining that the first data group and the second data group each comprise at least one common data element. Based on the at least one common data element, the first of the plurality of online entities can be associated with the second of the plurality of online entities. In a set of embodiments, a trust score can be assigned to the first online entity, based at least in part about information known about the second of the plurality of online entities.

Yet another method in accordance with a set of embodiments comprises obtaining an identifier associated with the online entity, maintaining a set of identifying data compiled from a plurality of data sources ( the set of identifying data might comprise a plurality of data elements of disparate types) and/or correlating the plurality of data elements to ascertain a relationship between the plurality of data elements. The method might further comprise searching the set of identifying data to identify one of the plurality of data elements as being associated with the identifier and/or, based on the relationship between the plurality of data elements, identifying the online entity.

In another set of embodiments, a method of creating an identification database might comprise harvesting, with one or more computers, data about a plurality of online entities from a plurality of data sources, storing the harvested data in at least one data store, identifying with a computer an online entity from at least some of the harvested data, searching the data store for additional information related to the online entity and/or associating the additional information with the online entity. The harvested data might comprise a plurality of data elements of disparate types, and/or the method might comprise correlating the plurality of data elements to ascertain a relationship between the plurality of data elements.

Another set of embodiments provides systems, including without limitation systems configured to perform methods of the invention. Yet another set of embodiments provides computer software programs, including without limitation programs executable to perform methods of the invention and/or programs implementable on systems of the invention.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral to denote one of multiple similar components. When reference is made to a reference numeral without specification to an existing sublabel, it is intended to refer to all such multiple similar components.

FIG. 1 illustrates a schematic diagram of a system that may be used to acquire information about online entities, in accordance with embodiments of the invention.

FIG. 2 illustrates a schematic diagram of a system that may be used to identify online entities, in accordance with embodiments of the invention.

FIG. 3 illustrates a schematic diagram of a system that may be used to implement an authentication framework for online entities.

FIG. 4 illustrates a method of identifying online entities, in accordance with embodiments of the invention.

FIG. 5 illustrates a computer system that can be used in various embodiments of the invention.

### DETAILED DESCRIPTION OF THE INVENTION

### 1. Overview

Embodiments of the invention provide novel systems, software and methods for gathering information about online entities and for identifying, evaluating and scoring such entities. Merely by way of example, the trustworthiness of an online entity, such as a domain, can be evaluated based information known about other online entities (e.g., the owner of the domain, other domains) associated with that domain. In an aspect of the invention, for example, publicly-available data (and, in some cases, other data) can be obtained and correlated to reveal previously-unknown associations between various online entities, despite, in some cases, the attempts of those entities to obscure such associations. This can facilitate evaluation of such entities. For instance, if a new domain is registered, there generally is little basis on which to evaluate the trustworthiness of that domain (other than facially-apparent characteristics, such as the domain name itself), since it has not yet begun operating. By ascertaining the domain's association with other online entities, however, information known about the reputation and/or behavior of those entities can be used to inform an evaluation of the domain.

Hence, various embodiments of the invention provide the ability to gather, correlate, search and/or analyze identifying information about online entities. Merely by way of example, in accordance with some embodiments, a plurality of diverse data sets may be acquired. The data sets can include, without limitation, WHOIS data, network registration data, UDRP data, DNS record data, hostname data, zone file data, fraud-related data, corporate records data, trademark registration data, hosting provider data, ISP and online provider acceptable use policy (“AUP”) data, past security event data, case law data and/or other primary and/or derived data related to the registration, background, enabling services and actual monitored record of an entity on the Internet. The data sets may be processed and/or saved in a format to allow cross-indexing and/or cross-referencing between various types of data. In particular embodiments, the data sets may be searched based on a search term to identify correlated data from among the various data sets. In this way, for example, correlated data (which previously may not have appeared to have any relationship to the search term) may be discovered to comprise identifying information and thus may be used to identify an entity based on the search term. Further, this identifying information may also be used as additional search terms (for instance, to narrow and/or broaden an earlier search), and thus may produce additional identifying or relationship information.

In some cases, the correlation between a set of data and an entity (and/or between two or more entities and their respective identifying information) may be relatively “strict,” in that two the identifying information is clearly associated with the entity. In other cases, the correlation may be relatively “loose.” For instance, certain embodiments of the invention may use “fuzzy logic” and/or other techniques to draw inferences between apparently unrelated data. Merely by way of example, even if two entities appear to be unrelated, the respective behavior (e.g., use of certain registrars or other enabling parties, content and/or format of web pages maintained by the entities, etc.) may be sufficient to provide an inference that the two entities are related, and the identifying information for one of the entities may be used as identifying information for the other entity.

Other embodiments of the invention allow for the scoring of an entity, based on that entity's identification, relationships, history, etc. This scoring information may be provided to third parties (such as users, administrators, ISPs, etc.) to allow those third parties to make determinations about the trustworthiness of the entity. Based on such determinations, the third parties may choose to take specific actions with respect to communications and/or data received from the entity. In a particular set of embodiments, a structure similar to a DNS system, with caching servers and/or authoritative servers, may be provided to allow third parties to obtain scoring (and/or other) information about a particular entity.

Certain embodiments, therefore, provide systems for tracking and/or ascertaining the identities of online entities. In this disclosure, the terms “entity” and “online entity” are used broadly and can include, without limitation, a person and/or business (such as the owner of a domain, the operator of a server, etc.), a domain name, a hostname, an IP address (and/or network block), a computer (such as a server) and/or any other person or thing that maintains an online presence and therefore is capable of being identified through embodiments of the invention. Particular embodiments, therefore, may comprise one or more databases (which may be global and/or searchable) that can be used to provide records, experience and/or other information about the ownership, relationship, historical, and/or behavioral attributes of entities on the Internet, including domain names, IP addresses, registrars, registries and ISPs. These databases may be used to investigate illicit activities, including without limitation phishing scams, trademark infringement, and other unsavory activities.

Embodiments of the invention also may be used to combine and/or correlate ownership, behavior, historic and/or reputation data from multiple sources to allow a user (such as an administrator, a client, etc.) to gather evidence against cyber criminals who might be, for example, misusing a client's intellectual property for financial gain. Embodiments of the invention, therefore, can be used to bring massive amounts of data together and organize the data to allow a user to ascertain patterns of behavior and correlated facts about a suspected entity, and/or allow for the development of a reputational database (such as the databases described in the Trust Applications, for example), where such information may be tracked, scored, etc. Such evidence may be used, merely by way of example, in a Universal Dispute Resolution Process (“UDRP”) complaint to retrieve a domain name, in civil and/or criminal litigation against a cyber criminal, when contacting an Internet Service Provider (“ISP”) to shut down an especially egregious site, etc. In some cases, embodiments of the invention may facilitate the creation of documents for such proceedings. Merely by way of example, the Reverse WHOIS Applications already incorporated by reference describe how information may be used to automatically create content for a UDRP complaint. Similar methods may be used to facilitate the drafting of various documents.

Other embodiments of the invention can be used to build a dossier on various entities, such as owners of suspicious Web sites, to identify locations (either physical and/or virtual) where cyber crimes and/or other illicit activities occur and/or find and track evidence needed to build a case against an online entity. Particular embodiments may be used to compile a portfolio of similar activities by a given entity, thereby showing a pattern of illicit activity. In accordance with some embodiments of the invention, reputational information may be compiled and/or tracked, allowing a prediction that a particular identified activity is likely to be illicit, to be a source of unwanted spam, to be associated with a computer virus, trojan, etc., and/or to be any other high-risk and/or undesirable activity. Such a predication may be based, for example, on the past activities of one or more entities associated with the identified activity. Thus, some embodiments of the invention allow for the provision and/or maintenance of a reputational database of online entities. Examples of reputational databases, as well as systems and methods implementing such databases, can be found in the Trust Applications, previously incorporated by reference. (The reader should note that the Trust Applications often use the term “trust database” to refer to such databases, and the term “trust evaluation system” to refer to systems that work with such databases).

The Trust applications provide a more complete description of the functionality of such systems, but a few examples follow. For instance, particular embodiments further provide the ability for a reputational database to interact functionally and/or to be used in conjunction with other authentication schemes, including without limitation DNS-based schemes, such as SPF, DomainKeys, etc., to provide authentication of the domain name and/or IP address as well as providing a score to inform a user, administrator and/or application of the probable risk that the entity associated with the domain name or IP address is who it purports to be. In some embodiments, the identifying information and/or aggregate history of the domain name and/or IP address may be analyzed and/or assigned a probability score for one or more risk and/or other characteristics.

Such a score might be made available to users (and/or others, such as administrators and/or applications) via a secure and/or authenticated communication, which might be matched with a domain name and/or IP address authenticated via one of the authentication schemes mentioned above. The user (or other) would be able to see and/or use the score, which could be provided in a fashion similar to existing DNS resolution schemes, to determine the probable risk that an entity behind an authenticated domain name and/or IP address is who it purports to be, and/or to use the transmitted data accordingly. Similarly, the score could indicate the likelihood that the entity is a source of fraud, abuse, unwanted traffic and/or content (such as spam, unwanted pop-up windows, etc.), viruses, etc. Such scores can also be used as input to inform a broader policy manager (which might operate on an ISP-wide and/or enterprise-wide level, for example), which dictates how specific traffic should be handled based on its score. Merely by way of example, based on the score for a given communication (such as an email message, HTTP transmission, etc.), that communication might be allowed, blocked, quarantined, tracked, and/or recorded (e.g., for further analysis), and/or a user and/or administrator might be warned about the communication. Other security and/or business policies could be implemented as well.

Such policies may be implemented in a variety of ways. Merely by way of example, a border device (such as a firewall, proxy, router, etc.) that serves as a gateway to an enterprise, etc. may be configured to obtain a score for each incoming (and/or outgoing) communication and/or, based on that score, take an appropriate action (such as one of the actions described above). As another example, client software on a user's computer may be configured to obtain a score for each communication and act accordingly. For instance, a web browser might be configured (via native configuration options and/or via a toolbar, plug-in, extension, etc.) to obtain a score for each web page downloaded (and/or, more specifically, for the entity transmitting the web page). If that score, for instance, indicated that the web page was likely to be a phishing attempt, the browser could warn the user of that fact and/or could refused to load the page (perhaps with a suitable warning to the user).

An email client application might operate similarly with respect to email. Merely by way of example, an email client (and/or a plug-in, component, stand-alone application, etc. operating in conjunction with an email client), upon receiving and/or downloading a new mail message, could be configured to obtain a reputation score for an entity responsible for sending the message (the identity of which could be obtained and/or verified through a variety of methods, including without limitation, a DNS lookup, a WHOIS search, consultation of an identity tracker, use of a verification service—such as DomainKeys, SPF, CallerID for Email, etc.—and/or the like) and/or a domain, host, IP address, etc. from which the message originates and/or was forwarded. Depending on the obtained score, the mail client (and/or plug-in, toolbar, stand-alone application, etc.) might take one or more of a variety of actions, including without limitation, accepting the message, quarantining the message, discarding the message, warning the user, an administrator, etc. that the message originates from a questionable and/or disreputable source, etc.

This concept may be analogized roughly to a credit score. Based on a history (generally of multiple inputs and/or security events) and/or with other ascertained identification information, a score may be derived and/or used in real-time, near-real-time and/or asynchronous transaction processing.

Thus, embodiments of the invention provide a robust framework for identifying and tracking online entities and/or their activities. Specific exemplary embodiments are described in further detail below.

### 2. Exemplary Embodiments

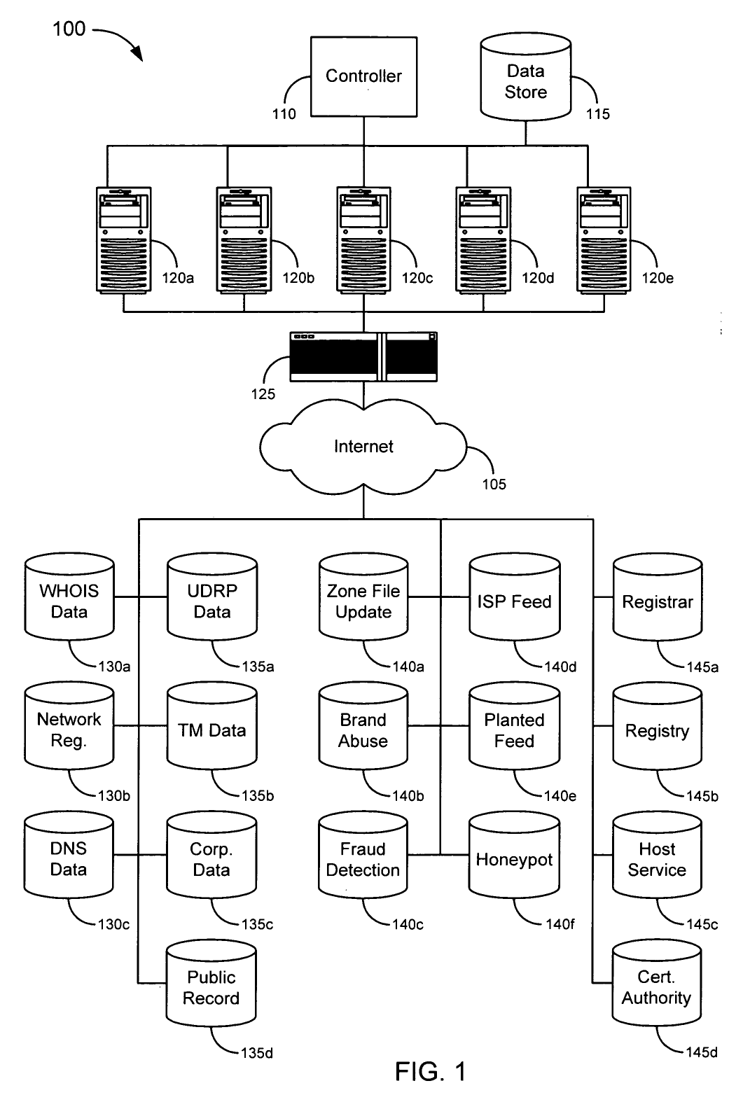

As noted above, one set of embodiments provides systems that may be used to gather information about online entities. FIG. 1 illustrates an exemplary system 100 that can be used to gather online information. The system 100 generally runs in a networked environment, which can include a network 105. In many cases, the network 105 will be the Internet, although in some embodiments, the network 105 may be some other public and/or private network. In general, any network capable of supporting data communications between computers will suffice.

The system 100 may also include a controller 110, which can be used to configure and/or control information harvesting operations, as described in further detail below. In particular embodiments, the controller 110 may be a system of one or more computers operating a controller application, which may be implemented in any suitable way. In a set of embodiments, the controller application is a Java application configured to communicate with a set of one or more harvesting servers 125. In operation, the controller 110 (based perhaps on instructions received from a user) may transmit instructions for reception by one or more of the harvesting servers 125. The instructions may be used to configure the server(s) 125 to perform particular harvesting and/or investigation operations as desired.

Investigation operations can include, without limitation, the investigation processes described in detail in the Anti-Fraud Applications already incorporated by reference. Harvesting operations, some of which are also described in the Anti-Fraud Applications, can include any operation designed to obtain data, including, inter alia, from sources 130-145 of data on the Internet. Such sources can include, without limitation, sources 130 of registration data, including without limitation one or more WHOIS databases 130a, network registration databases 130b (such as, for example, databases maintained by ARIN, APNIC, LACNIC, RIPE and/or other entities responsible for allocating and/or maintaining records of IP addresses and/or networks), and/or DNS databases or tables 130c (which may contain information related to DNS addressing of various hosts and/or networks). Sources of data can further includes sources 135 of background data, including, merely by way of example, UDRP databases 135a (which may contain data related to UDRP complaints filed against cybersquatters and others), trademark databases 135b (which may contain information relating to ownership of registered and/or unregistered trademarks), corporate records databases 135c (which may contain information related to the identities and/or ownership of various business entities, including but not limited to corporations), and/or other public records 135d, such as property records, telephone directories, etc.

Further sources of data can include data 140 compiled and/or derived through monitoring, crawling and/or anti-fraud operations, including without limitation such operations as described in the Anti-Fraud Applications. Such data can include, merely by way of example zone file updates 140a (which can comprise comparisons or “diff” files of changes from one version of a zone file to the next, and which may allow relatively expeditious ascertainment of new and/or modified domain registrations), records 140b of brand abuse, results 140 of fraud detection and/or prevention operations and/or investigations, ISP feeds 140d (which can comprise one or more email feeds of potential spam and/or phish messages, as described in more detail in the Anti-Fraud Applications), feeds and/or results of planting operations 140e (examples of which are also described in the Anti-Fraud Applications), and/or data 140f obtained/received by one or more honeypots, examples of which are described in the Anti-Fraud Applications.

Data 145 from and/or about enabling parties may also be obtained and/or used by embodiments of the invention. An “enabling party,” as that term is used herein, can be any party that provides services facilitating an entity's presence on the Internet. Examples of enabling parties can include, without limitation, registrars 145a and/or registries 145b, hosting providers 145c, ISPs (not shown on FIG. 1), DNS providers (not shown on FIG. 1), certificate authorities 145d, and/or the like. Data about and/or from these parties can include data compiled and/or maintained by these providers about their customers, data about the providers themselves (including, merely by way of example, identifiers such as IP addresses, domains, network blocks, etc. that may identify a provider), trends and/or amenability of a given provider to facilitate illicit activity, historical behavior of customers of a given provider, etc.

Data may be obtained and/or accessed from such sources by a variety of methods. Merely by way of example, a server 120 may be configured to crawl a WHOIS database 130a to obtain WHOIS information about a variety of domains or other entities, perhaps on a periodic basis. In other embodiments, a server 120 may be configured to access a WHOIS database 130a to find information about a particular domain and/or entity. This information may also be saved in a database incorporated within the system, which can allow for additional analysis of the data, as described below, for example. In a particular embodiments, a server 120 may be configured to obtain a zone file 140a on a periodic (e.g., daily) basis. The zone file 140a may be downloaded by the server 120 to a data store 115, perhaps for further analysis (e.g., as described in detail below).

In similar fashion, network databases 130b may be accessed to obtain information about IP address allocation (including, for example, the entity to which a particular IP address or network is allocated), and UDRP databases 135a may be accessed to obtain information about UDRP proceedings (including, for example, entities against whom UDRP complaints have been initiated and/or domains that have been subject to UDRP proceedings). Trademark databases 135b and/or corporate databases 135c may be accessed to obtain identifying information about trademarks (including information about owners of various trademarks) and/or corporations. DNS tables and/or databases 130c may be accessed to obtain various identifying information about IP addresses and/or networks, including for example, information about the name servers assigned to a particular domain or host, etc. Likewise, data may be obtained (via crawling, data file transfer, messaging forwarding, etc., as appropriate) from a variety of sources (including without limitation sources 130-145) of data. All of this information may be accessed (e.g., in real time as needed), downloaded and/or otherwise obtained, and/or it may be placed in a data store 115 (which, in some embodiments, may be a plurality of data stores). The Anti-Fraud Applications and the Trust applications each discuss additional data sources and methods of acquiring data therefrom, all of which may be incorporated and/or implemented by embodiments of the present invention.

In accordance with some embodiments, the harvesting servers 120 may be configured to use an IP address allocator 125 to enable harvesting from databases designed to prevent automated harvesting. The allocator 125 may be configured to function in a manner similar to a megaproxy, as described in detail in the Anti-Fraud Applications.

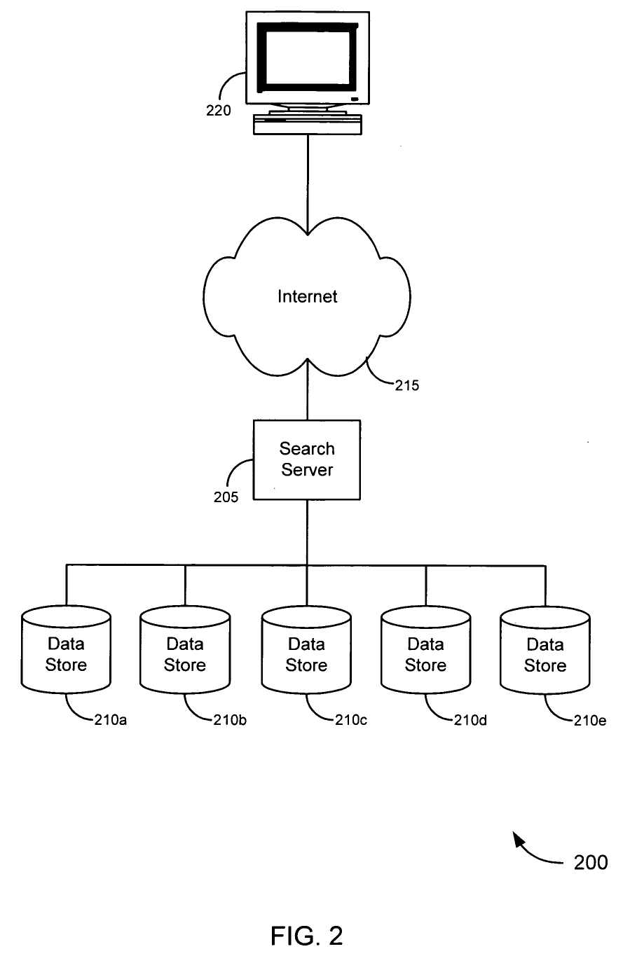

FIG. 2 illustrates a system 200 that can be used to ascertain and/or track the identity of an online entity. The system 200 may comprise a search server 205 (also referred to herein as an “identity server”), which may be used to perform searches for identifying information associated with a particular search key, which can be any information about an online entity (such as a personal name, corporate name, physical address, telephone number, domain name, hostname, IP address, registrar, ISP, etc.). The system 200 may also comprise one or more data stores 210, which may be used to store data (which may have been obtained through harvesting and/or investigation operations, as described above, for instance). In accordance with particular embodiments, the system may be accessed (e.g., via the Internet 215 and/or through any other private or public network) by a client computer 220, which may be operated by an administrator, a customer, etc.

The data store(s) 210 (which may be similar to and/or derived from the data store 115 described with respect to FIG. 1) may comprise data gathered through a variety of harvesting/investigation information, including without limitation the data described above. Other examples of data that may be harvested and/or included in the data store(s) 210 include data obtained from public records (which can include telephone directories, governmental filings, etc.), data from enabling parties (such as ISPs, registrars, hosting providers, certificate authorities, etc.). The data may be stored in the data stores 210 in a variety of ways. Merely by way of example, in accordance with some embodiments, harvested data may be parsed for certain fields (including without limitation personal and/or corporate name, physical address, telephone number, full and/or partial IP address, hostname, domain name, etc.). As those skilled in the art will appreciate, some of the harvested data may prove to be resistant to parsing (due to the format of the data, etc.), and such data may be retained in full-text form for full-text searching, etc.

The data stored in the data store(s) 210 may also be cross-indexed and/or cross-referenced, based on matching or similar information. Merely by way of example, if a harvested WHOIS record contains information for a particular domain, and a harvested DNS record provides name server information for a host in that particular domain, the information in the DNS record may be cross-indexed and/or cross-referenced against the appropriate WHOIS record. Likewise information (such as registered owner) in a network record associated with the IP address of the name servers may also be cross-indexed and/or cross-referenced against the information from the WHOIS record and the DNS record. Moreover, if data harvested from a UDRP complaint references a domain name associated with that domain, the information in the UDRP complaint may be cross-indexed and/or cross-referenced against all of these records. Based on these examples, one skilled in the art will appreciate that a wide variety of cross-references and/or cross-indexes may be performed in accordance with embodiments of the invention.

Consider, then, a case in which a search is performed for a particular individual. If that individual was the respondent in the cross-indexed UDRP proceeding, the search results will include all of the information from the cross-indexed records, allowing for a relatively more complete identification of the individual.

Embodiments of the invention also provide for data grouping and re-grouping. If it is determined, for instance, that the identified individual also owns other domains, information about those domains may be associated and/or grouped with the already cross-indexed information. This process can continue until a detailed map of the individual's online activities is established.

This feature can provide predictive functionality as well. For example, if a particular individual is associated with a known phishing scam, any other IP addresses, domain names, etc. associated with that individual (through, for example, a cross-indexing operation), may be assumed to be relatively more likely to be involved in phishing scams as well. Through these cross-indexing associations, trend information may be revealed as well. Merely by way of example, an analysis of associations may reveal that a particular ISP, domain name registry and/or name server is relatively more likely to be a provider for phishing operations. Other domains and/or IP addresses associated (again, through the cross-indexing procedures) with that provider may then be relatively more likely to be involved in illicit activities.

In this way, the system 200 may be used to develop a reputational database, including without limitation a reputational database as described in the Trust Applications. For any online entity, for example, an analysis of all cross-indexed associations can allow a relatively confident determination of whether that individual is involved in illicit online activity. Merely by way of example, if a domain owner uses the services of a registry and/or ISP known to be friendly to phishers, it may be relatively more likely that a web site hosted on that domain may be a phish site. These relationships can easily be ascertained through the cross-indexing and cross-reference relationships supported by embodiments of the invention.

In an aspect of the invention, a reputational database can provide a historical view of an entity's activities. Merely by way of example, if it is discovered that a given entity is engaging in an illicit activity, such as phishing, a record of the activity may be made with respect to that entity. Further, a record may be made with respect to each of the enabling parties associated with that entity, thereby tagging or labeling such enablers as being relatively more likely to facilitate illicit activities. Each time an enabling party is discovered to be a facilitator of such activity, a “count” or score may be incremented and/or otherwise adjusted. This can allow interested parties to determine quickly whether a given enabling party is relatively more or less likely to act as a facilitator of illicit activity, which can provide insight into the likelihood of a entity associated with such an enabling party to be engaged in an illicit activity and/or can allow the preparation of a complaint against an enabling party, etc. As an example, if a particular registrar is found to register domains frequently for cybersquatters, that information can inform a determination of whether a new domain registered with that registrar might be a cybersquatting domain. Likewise, the ability to show a proven history of registering cybersquatters may provide helpful evidence in prosecuting a complaint (with a body such as ICANN, etc.) against such a registrar.

Embodiments of the invention, therefore have a variety of applications. Merely by way of example, if an anti-fraud operation reveals a spam message with a link to a particular web site, the search server 205 may be configured to search for any information associated with that web site. If the search reveals that the web site is hosted by an ISP known to host other fraudulent web sites, the web site may be scored as a likely phish site, even if an examination of the WHOIS record for the domain may not reveal any anomalies.

As another example, consider a trademark owner who wishes to identify a cybersquatter. The trademark owner (perhaps using the client 220) can request from the search server 205 a search for all information associated with the domain. Those skilled in the art will appreciate that WHOIS records (especially for illicit domains) often contain incorrect and/or falsified information. In accordance with embodiments of the invention, however, the search server 205 can search for all data cross-indexed against the domain. Such data often will include identifying information that may be used by the trademark owner to identify the actual owner of the infringing domain. Further, the system 200 can provide an indication of whether that domain owner has ever been involved in any UDRP proceedings, allowing the trademark owner to produce a more effective argument for a UDRP complaint and/or any other appropriate action.

Thus, embodiments of the invention can serve as a sophisticated form of reverse WHOIS, and methods similar to those described in the Reverse WHOIS Applications may be implemented in accordance with embodiments of the present invention. Unlike traditional reverse WHOIS services, however, embodiments of the invention provide much more data, often from a variety of diverse searches, from which to draw identifying information.

As another example, embodiments of the invention may be used to provide a security and/or authentication service to users, companies, ISPs, etc. Merely by way of example, certain service providers (such as ISPs, etc.) provide domain hosting and other e-business services on a “bring your own domain” basis, where a customer who already has registered a domain wishes to have the provider host certain services on that domain. The service provider, however, might wish to ensure that the domain (and/or the customer owning the domain) are not associated with any domains (or other online entities) engaged in unsavory online practices, such as cybersquatting, spam, online fraud, etc. The service provider, then, might employ the identification and/or reputational features of embodiments of the invention to ensure that the prospective customer does not have a history of unsavory activities before agreeing to provide services that might allow the prospective customer to impugn the reputation of the service provider itself.

In addition, embodiments of the invention can be used to provide a “whitelisting” service, whereby newly-registered domain can be considered to be legitimate, based any of a variety of factors described herein, including without limitation its association with other legitimate domains (either by ownership or by other factors described elsewhere herein). Similarly, an domain and/or an entity could be blacklisted, based on similar factors. A domain (or another entity) could also be given an initial reputation score, based on its associations, with additional factors based on the entity's own behavior possibly being used to update the reputation score at a later time.

In some embodiments, for instance, a provider may provide and/or maintain reputational and/or scoring databases for use by its customers. Such databases may be consulted to determine the relative reliability of various online entities. In a particular embodiment, the scores may be, as noted above, analogous to credit scores, such that each entity is accorded a score based on its identifying information, relationship information, and history. Such scores may be dynamic, similar to credit scores, such that an entity's score may change over time, based on that entity's relationships, activities, etc. Merely by way of example, a scoring system from 1 to 5 may be implemented. Scores of 1 or 2 may indicate that the entity is relatively likely to be reputable (that is, to be engaged only in legitimate activities), while a score of 3 may indicate that the identification and/or reputation of an entity is doubtful and/or cannot be authenticated, and scores of 4 or 5 indicate that the entity is known to engage in and/or facilitate illicit activity. (It should be noted that the scoring scheme is discretionary, and that the scheme discussed above is merely exemplary in nature).

In a set of embodiments, the scores are provided as a relatively objective determination of the trustworthiness of an entity. A user, company, ISP, etc. may make its own determination of how to treat communications, data, etc. from an entity, based upon that entity's score. Merely by way of example, a company and/or ISP might configure its mail server to check the score of each entity from whom the server receives mail, and to take a specific action (e.g., forward the mail to its intended recipient, attach a warning to the mail, quarantine the mail, discard the mail, etc.) for each message, based on the score of the sending entity. As another example, a web browser might be configured to check the score of web site when the user attempts to access the site and take a specific action (e.g, block access to the site, warn the user, allow access to the site, etc.), based on the score of the web site (and/or an entity associated with the web site).

Certain embodiments may be implemented using a structure similar to the DNS structure currently in place. Merely by way of example, a security provider might provide an authoritative scoring server, and various entities (ISPs, etc.) might provide caching scoring servers. If a score lookup is needed, an assigned caching server might be consulted, and if that caching server has incomplete and/or expired scoring information, an authoritative server might be consulted. Similar to the DNS system, root servers might exist to arbitrate the relationship between caching servers and authoritative servers. In particular embodiments, however, unlike DNS, the security provider (and/or another trusted source), would have control over the dissemination of scoring information, such that the scoring servers could not be modified by third parties, and scoring information could not be compromised, either in transit or at the caching servers. Secure transmission and storage protocols thus might be implemented to ensure data integrity.

Some embodiments can be used to identify and/or evaluate entities associated with new domains of concern (and/or to evaluate the domains themselves). Merely by way of example, if a new domain is registered that is suspiciously similar to an existing domain, that might be considered a domain of concern. For instance, if the domain anybank.com is an existing domain owned by a reputable bank, and a new domain anybank-online.com is registered, that new domain might be of concern. (U.S. patent application No. 10/996,566, already incorporated by reference, describes systems and methods that can be used to identify domains of concern.) If the new domain is registered by the legitimate bank, there is no problem. However, if the new domain is registered to another, there is a risk that it might be used for cyberquatting and/or online fraud. Embodiments of the present invention can be used to help evaluate that risk, for instance by determining whether the new domain is associated with the legitimate bank.

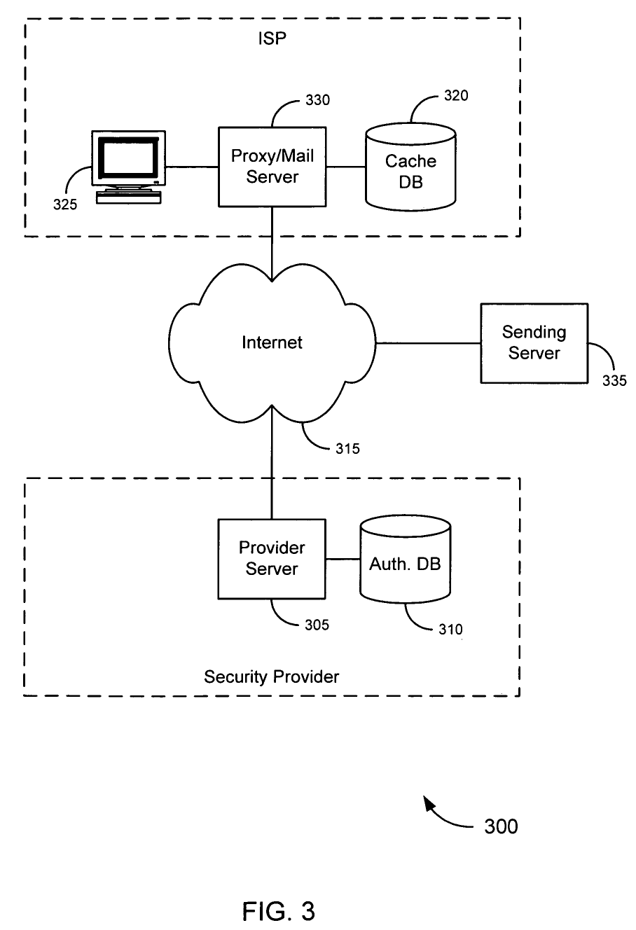

FIG. 3 illustrates a system 300 that may be used to implement an authentication framework, such as that described above. A security provider might provide a trust authentication server 305 (which might be, but need not be, incorporated within and/or in communication with a search server 205, as described above) to providing authentication and/or scoring services. In the illustrated embodiment, the trust authentication server is in communication with an authoritative scoring database 310, which maintains an authoritative record of identified online entities, along with their respective scores. The provider's trust authentication server 305 and/or authoritative database 310 may be in communication (e.g., via the Internet 315) with a caching database 320, which caches at least a subset of the information maintained by the authoritative database (and which may be associated with a caching server (not shown on FIG. 3)). The caching database 320 may be operated by an ISP (although, as noted above, the security provider might have sole authority to modify scoring data in the database 320) The caching database 320 can provide scoring (and/or other) information for the ISP's customers and/or others.

As noted above, in operation, certain embodiments of the invention can provide scoring information (and/or other information, including without limitation reputational information) for use by a user, an ISP, an application, etc. As a first example, consider a situation in which a server 335 attempts to send an email message to a user using a mail client on a user computer 325. The sending server 335 routes the message (usually via the Internet 315) to the mail server 330 for the user's ISP (or corporation, etc.). In accordance with an embodiments of the invention, the mail server 330, upon receiving the message, examines the message to determine an identifier (such as a host, domain, IP address, etc.) of the sending server 335. The mail server 330 then queries the local caching database 320 for scoring (or other) information about the sending server 335. If the caching database 320 has relevant information that has not expired, the caching database 320 (and/or a server associated therewith), transmits this information to the mail server 330. If the caching database 320 does not have the requested information (or has an expired version of the information), the caching database 320 (or, again, a server associated therewith), may refer the mail server 330 to, and/or forward the request to, an authoritative database 310, a root database or server, etc., perhaps in a fashion similar to the caching and retrieval methods implemented by DNS systems, and such a database or server provides the requested information, either to the caching database 320 and/or the mail server 330. Upon receiving the scoring information, the mail server 330 may make a determination of how to handle the message, including without limitation any of the options mentioned above.

In an alternative circumstance, the sending server 335 may be a web server, and/or the mail server 330 may be a proxy server. When a user (using the client 325) attempts to access a web page at the web server 335, the proxy server 330, before transmitting the HTTP request (and/or the response from the server), may consult the caching database 320 (in a manner similar to that mentioned above). Based on the scoring information received, the proxy server 330 may determine an appropriate action to date, including without limitation any of the actions mentioned above.

Alternative configurations are possible as well. Merely by way of example, it may be more appropriate in some situations (such as when the client 325 and mail server 330 are configured with a POP3 relationship, and/or when the client 325 does not use a proxy server 330 to access the Internet 315), for software on the client 325 to perform the scoring request and evaluation steps. For instance, a software firewall on the client 325 could be configured to limit incoming and outgoing transmissions according to the score accorded the transmitting/receiving server, domain, etc. Alternatively and/or in addition, specific applications (such as mail clients, web browsers, etc.) could be configured to take advantage of this functionality as well.

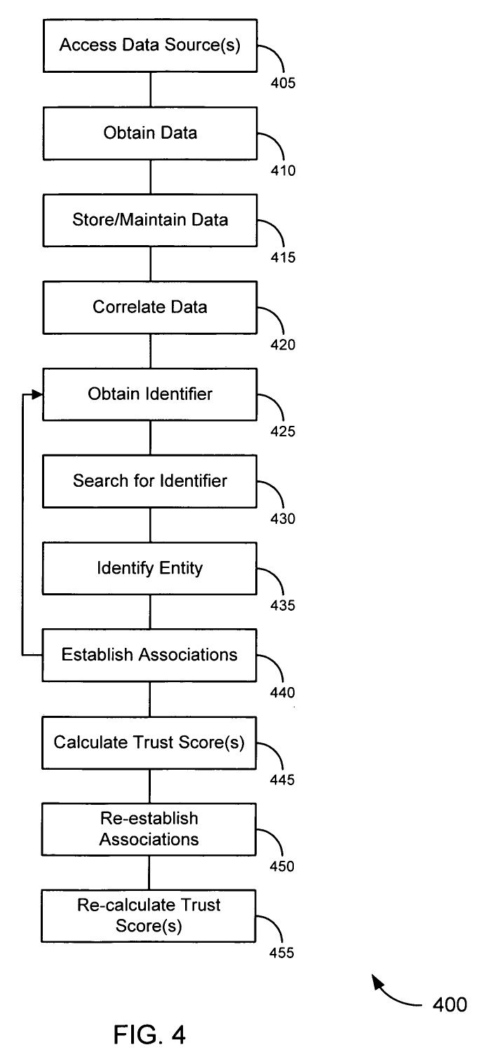

FIG. 4 illustrates an exemplary method 400, which may be used for a variety of purposes. Merely by way of example, the method 400 can be used to identify an entity, based, for example, on identifying information obtained from one or more data sources, from information correlated against another, previously-identified entity, etc. As another example, the method 400 can be used to calculate a trust score, which may be used to populate a trust database, reputational database and/or the like, as discussed, for example, in the Trust Database Applications. The method 400 may also be used to create, maintain, update, etc. an identity database, which may be provided (for example, to a third party) for use in identifying entities and/or for other suitable purposes.

The method 400 may comprise accessing one or more data source(s) (block 405), including without limitation the data sources discussed above. In accordance with some embodiments, a distributed harvesting system, such as the systems discussed above, for example, may be used to access the one or more data sources. In other cases, one or more computers (which may be clients, servers, etc.) may access data sources. This process may be user-controlled, automated, etc. A data source may be performed using any appropriate protocol: those skilled in the art will appreciate that various data sources may need to be accessed using different methods. Merely by way of example, some data sources may be accessed using FTP, while others may be assessed using WHOIS, HTTP, TELNET, etc. In some cases, accessing the data source(s) may involve the use of an address allocator, such as the system described above. Merely by way of example, accessing a particular data source may be an iterative process (e.g., accessing a WHOIS database might comprise making multiple WHOIS requests to that database), and those skilled in the art will appreciate that certain data sources are configured not to allow multiple accesses within a particular window of time. An address allocator, then, may be used to allow a harvesting computer, etc. to make multiple accesses, for instance by providing a different IP address for some or all of these accesses.

The method 400 may further comprise obtaining data from the data source(s) 410. In some implementations, obtaining data may comprise downloading data from the data sources, while in other implementations, obtaining data may comprise merely accessing the data in situ at the data source(s). In a particular set of embodiments, one or more harvesting computers, for example, may download data from a data source and/or forward that data (using any appropriate protocol) to one or more data stores and/or identity servers. In another set of embodiments, the harvesting computer(s) may serve as the identity server(s), a search server (described above) may serve as an identity server, and/or a control computer may serve as the identity server.

At block 415, the obtained data may be stored and/or maintained, e.g., in one or more data stores. In a particular set of embodiments, maintaining data may comprise periodically accessing data source(s), obtaining data, and/or updating stored data with newly obtained data. Maintaining data may also comprise merely storing the data in a form that may be accessed by processes implementing embodiments of the invention.

Embodiments of the invention may provide relatively sophisticated data acquisition and/or conversion routines, and the procedures for storing and/or maintaining data may implement such routines. Merely by way of example, those skilled in the art will appreciate, as mentioned above, that data accessed and/or obtained by embodiments of the invention may be stored in a variety of structured and/or unstructured formats. For instance, even with regard to WHOIS data, various WHOIS databases store data in a variety of ways, and there is little adherence to any common standards. Moreover, may WHOIS database providers perform little (if any) enforcement of policies requiring customers (and/or others) to provide correct and/or consistent data. Thus, data obtained from WHOIS databases may be in a variety of formats and/or may be substantially incomplete and/or incorrect.

This problem is merely compounded by the diversity of data sources used by embodiments of the invention. Often, while a given data source may provide data to be harvested, the data source will provide little information about how the data is structured and/or what the data even means. When multiplied by the number of data sources from which data is typically obtained, these challenges make organizing and/or storing the obtained data in a usable format a non-trivial challenge.

Some embodiments of the invention, therefore, use relatively sophisticated processes for interpreting, converting and/or saving data. Merely by way of example, if a batch of unformatted data has been obtained, embodiments of the invention may be configured to parse the data to identify various data elements. A data element can be any discrete piece or set of data, and data elements may be formed from a variety of data, including harvested data, data from investigations, data from anti-fraud operations, etc. Thus, a given data element might comprise one or more names, phone numbers, addresses, and/or identifying information, information about behavioral patterns and/or historical data, etc. In a particular set of embodiments, for a particular entity, there might be a data element corresponding to the entity's name, a data element corresponding to the entity's IP address, a data element corresponding to a known or suspected phishing scam operated by the entity, a data element corresponding to the entity's ISP (and/or any other enabling party), etc. In particular cases, if structured data is obtained, a data element might correspond to a field from a record in the data.

For instance, if a batch of data comprises multiple records having a similar data structure, those records (either one-by-one or collectively) may be analyzed by the system. In some cases, particular data elements (such as telephone numbers, social security numbers, IP addresses, etc.) may be identifiable based on their format. In other cases, particular keywords (such as common given names and/or surnames; common address terms, such as “street,” “drive,” “north,” “south,” etc.; common strings, such as “.com,” etc may be used to infer the type of data element to which such keywords pertain). In particular embodiments, if one or more data elements in a particular record (or records) can be identified, those data elements may be used as a template to interpret other records. Other parsing algorithms and procedures may be used as well.

In some cases, obtained data may be in a state that makes parsing the data for data elements unfeasible. For example, the data may have so little structure that parsing algorithms can make no sense of the data. In such cases, storing and/or maintaining the data may comprise storing the data in a raw format (e.g., as a flat text file, as a text field in a database record, etc.). This can allow the data to be searched, even if unformatted, for information (e.g., strings, etc.) that may match data elements, as described in more detail below.

In accordance with embodiments of the invention, the data may also be correlated (block 420). Correlating data may comprise identifying associations and/or similarities between various groups of data. Merely by way of example, one skilled in the art will appreciate, based on the disclosure herein, that data may be obtained and/or accessed in groups. A data group may comprise one or more data elements that share a common characteristic; merely by way of example, an embodiment of the invention may download a record from a particular data source, such as a motor vehicle registration database, and that record may comprise a plurality of related data elements, such as the VIN number of the vehicle; the name, address, driver's license number, and/or other identifying information about the owner; the purchase price of the vehicle, etc. Each of these data elements, having been obtained from a single record, can be considered related and therefore may comprise a data group. (Those skilled in the art will appreciate that there are a variety of well-known ways, both explicit and implicit, to associate data elements within a given group. Merely by way of example, all of the elements in a data group may be stored, e.g. as fields, within a given data record, which might represent the data group. Alternatively and/or in addition, there may be relational and/or symbolic links established between various data elements in a given group, etc.).

Correlating data elements, then, may comprise identifying each of the data elements within a given group and/or searching one or more data stores for any data elements matching and/or associated with one of the data elements within a given group. Merely by way of example, returning to the motor vehicle record discussed above, the system may search the data store(s) for any data element(s) matching a data element in the group from the motor vehicle record. Any matching data element(s) (and, optionally, the data group(s) comprising those data element(s)) then may be associated (e.g., by creation of a new record comprising the matching data element(s) and/or the data group(s) comprising those elements, by creating a relational and/or symbolic link between the data element(s) and/or group(s), etc.). Thus, for example, if a particular data group comprises elements from a WHOIS record, and one of those data elements (e.g., an address) matches a data element (e.g., an address) of the data group associated with the motor vehicle record, those two groups (and/or elements of those two groups) may be correlated, e.g., by cross-referencing, cross-indexing etc.

As mentioned above, embodiments of the invention may support re-grouping of data elements. That is to say, if an association is found between two or more data elements, those associated data elements may be correlated into a new data group (which may be a replacement of and/or an addition to the original group(s) that held those data elements—a given data element may be a member of multiple data groups). Thus, as an alternative (and/or addition) to correlation by cross-referencing and/or cross-indexing, correlating data elements may comprise creating a new data group comprising the groups and/or elements, etc.

Also as mentioned above, correlating data elements may involve inferential processing, fuzzy logic and/or additional advanced correlation procedures. For instance, in some cases, two data elements (and/or groups) may not appear to be correlated, but a third data element (and/or group) may provide additional information allowing for the correlation of those two data elements. Merely by way of example, if a first data group (perhaps harvested from a telephone directory, etc.) contains a particular name and phone number, but no name, a second data group contains the same phone number and a domain name (perhaps, for example, the second data group comprises data elements found through harvesting a web site at a particular domain, and the phone number was listed as a support number for the web site), and a third group contains data elements from a WHOIS search for the domain, those three data groups may be correlated to produce a data group comprising a name, address, and/or phone number (as well, perhaps as any additional data elements from any of the data groups) associated with the domain. In this way, the owner of the domain (who may have attempted to mask the true ownership of the domain) may be identified. Based on this simple example, one skilled in the art can appreciate how embodiments of the example may correlated a relatively large number of data groups based on “chains” of data elements between those groups.

As another example of the inferential processing supported by embodiments of the invention, consider a situation in which two domains, which appear unrelated (based, for example, on WHOIS records for the two domains, which contain no common information) both are associated with common enabling parties (registrars, ISPs, name servers, etc.) and/or happen to reside on a single network block. An inference may be made that the two domains are in fact related, based on the high correlation between the way both domains are setup and maintained. Further inferences may be drawn, for example, based on the behavior two apparently separate domains. Merely by way of example, if two domains, upon investigation, are shown to have engaged in the same (or similar) illegitimate practices (such as a common phishing scheme, trademark scam, etc.), an inference may be drawn that the two domains are associated (either through common ownership, through some formal or informal business relationship, etc.).

As noted above, there may be cases in which data is stored in a raw format. In such cases, correlating data may comprise searching (using, for example, any of several known full-text search algorithms) such data for information matching any of the data element(s) and/or groups currently being analyzed. Any matching information may then be examined (by an automated process, by a technician, etc.) to determine whether the information can be correlated with the data elements and/or groups. Merely by way of example, an automated process may be configured to search for any information matching a data element and then associate that information (perhaps a string, etc.) and/or a certain amount of surrounding information (which may be relatively likely to be related to the matching information) with the data element. Optionally, a new data element may be created from such information. Alternatively, and/or in addition, the matching information (and perhaps a certain amount of surrounding information) may be provided (e.g., in a pop-up window, in an event in an event manager, in an email message, etc.) to an administrator so that the administrator can determine whether the matching information and/or the surrounding information (as well, perhaps, as how much of the surrounding information) is associated with the data element being analyzed.

Other modifications of this procedure are possible as well. Merely by way of example, raw data may be searched for occurrences of two or more data elements in a particular data group. If the two or more elements are found in the raw data, the raw data (and/or a portion thereof, as described above, for example) may be associated with the data group and/or the particular elements. Similarly, one or more new data elements may be created for such raw data, and/or such new data elements may be incorporated within one or more new or existing data groups, as described above.

Based on this disclosure, and that of the Trust Database Applications, one skilled in the art will appreciate that correlations between various data elements and/or data groups may in some cases be probabilistic. That is to say, embodiments of the invention may determine that there is a probability (which may or may not be quantified) that any two (or more) data elements and/or groups may be associated. These probabilistic relationship may be stored and/or confirmed as more data becomes available (e.g., through normal harvesting operations, through particular investigation of one or more web sites, etc.).

It should be noted as well that the correlation process can be iterative. That is, if a first data element (and/or group) is found to be associated with and/or related to a second data element (and/or group), and the second data element (and/or group) is found to be associated with and/or related to a third data element (and/or group), the first data element (and/or group) may be correlated with the third data element (and/or group). This process may continue with a fourth data element (and/or group) that is found to be associated with and/or related to any of the first three data elements (and/or groups), etc. In this way, a mapping of relationships and/or associations may be established, such that for a given entity (or data element, data group, etc.), one can ascertain, to whatever level desired, all of the entities (or data elements, data groups, etc.) related to and/or associated with that entity, data element, group, etc. This mapping can assist, for example, in the creation of a reputational and/or trust database, assist in the identification of entities, and/or the like.

Certain embodiments of the invention may be used to identify an online entity, perhaps using data obtained and/or correlated as described above. At block 425, therefore, an identifier may be obtained and/or provided. As noted above, an identifier can be any information, such as a personal, corporate and/or domain name, a physical and/or IP address, etc., that may be used to identify an online entity. In some cases, the identifier may be associated with an unidentified entity. In other words, the identifier may be the only information known about the entity and/or may be part of a set of information that is insufficient to identify the entity. Merely by way of example, consider the case in which an entity registers a domain name and fails to provide complete information in the WHOIS record for the domain, but the information provided includes an administrative contact email address. The email address, therefore, may be the identifier. In other situations, other information may be used as an identifier.

In particular embodiments, obtaining an identifier might comprise receiving an identifier as input from another process (e.g., any of the investigation and/or fraud detection/prevention processes discussed in the Anti-Fraud Applications, an entity evaluation process such as the processes discussed in the Trust Database Applications, an entity identification process, etc.) and/or from a user (who might be a customer, administrator, and/or the like). In other cases, obtaining an identifier might comprise identifying an identifier from a batch of obtained data. Other procedures for obtaining an identifier are possible as well.

At block 430, a search may be performed for any data elements that correspond to the obtained identifier. In some embodiments, the search may comprise searching a database for data elements and/or data groups that are identical and/or similar to the identifier. In some embodiments, this search may be similar to the search performed in the correlation process for data elements, discussed above. Any suitable search algorithm known in the art may be used to perform such searches. In a particular set of embodiments, for example, the search may be a SQL query on the identifier.

Further, an entity to which the identifier pertains may be identified (block 435). In many cases identifying the entity may be accomplished by associating any data elements and/or data groups returned by the search with the identifier. Merely by way of example, if the identifier was a phone number, and the search returned a data group associated with a telephone listing for a particular person or corporation, that person or corporation may be identified as the entity to which the identifier pertains. In some embodiments, a new data group may be formed to incorporate one or more data elements in the group comprising the identifier with one or more data elements in the group comprising the search results. In other embodiments, one or more existing data groups may be modified to account for the identification of the entity (for example, the data group comprising the search results may be updated to include any additional data elements from the data group comprising the identifier, and/or vice-versa). Depending on how the identifier was obtained, the identification of the entity may be returned (e.g., to the process providing the identifier, to a user who requested the identification of the entity, etc.).

The method may also include establishing any associations with an identified entity (block 440), including without limitation an entity identified as discussed above. The process of establishing an entity's associations may be similar to the process for correlating data, discussed above, in that, according to certain embodiments, the data store may be searched for any data matching one or more of the data elements related to a given entity, and/or for any entities having data matching the one or more data elements related to the given entity. If any matching information (e.g., data elements, data groups, entities, etc.) is found, the entity or entities related to that information may be associated with the given entity. Similar to the correlation of data, above, the associating process may be reiterated as appropriate, allowing for association of entities to varying degrees (e.g., if Entity A is associated with Entity B, all other entities associated with Entity A are also associated with Entity B). In this way, an association map may be established for some or all of the entities recorded in the data store.

The operations described with respect to blocks 425-440 may be performed iteratively. Merely by way of example, in block 440, a set of associations are developed for a particular entity. Each of the entities associated with the originally-identified entity might have a corresponding identifier (such as a domain name, domain registrant email address, etc.), and each of these identifiers might be used as input to block 425. Each identifier then would be searched (block 435), and additional entities corresponding to those identifiers could identified, etc. The process can be repeated, perhaps until no further associations are ascertainable. In this way, embodiments of the invention can establish a mapping of associations among various entities.

In some implementations, a trust score may be calculated for an identified entity (block 445). In accordance with particular embodiments, a trust score may be calculated based on the identifying information (e.g., data elements) related to the entity, and/or based on the entity's associations (which may be established as described above). As described in the Trust Applications, a variety of behavioral, associative and other factors may be used to determine a trust score. An initial trust score, however, may be calculated based on the identification of the entity and any related/associated entities. Merely by way of example, if an identified entity is a domain name, and that record for that domain name includes a registrant email address (which can be considered an associated entity) that is also associated with a number of domains known to be involved in illegitimate activities (cybersquatting, fraud, spam, and/or the like), the identified domain might be assigned a relatively low initial trust score (which, of course, might be updated based on the activities subsequently undertaken using that domain).

In some cases, assigning a trust score to an entity can be performed in automated fashion, based at least in part on the entity's associations, as noted above. In other cases, however, the scoring procedure might necessarily involve human judgment. In such cases, embodiments of the invention might be configured to automate as much as feasible the analysis and/or scoring of the entity. At that point, the system might be configured to create an event in an event manager system (such as those described in the Anti-Fraud systems, for example), to indicate to a human operator that human judgment and/or analysis is required to assign an initial score to the entity. The event manager, then, can provide for the ability to prioritize tasks. Merely by way of example, if a customer has inquired about a suspect domain, and the initial (automated) analysis indicates that the domain is associated with entities known to be engaged in illegitimate activities, it might be assigned a relatively high priority in the event manager.

One skilled in the art will appreciate that the Internet is a dynamic environment. Accordingly, associations between various online entities cannot always be assumed to be static. In a set of embodiments, therefore, the method 400 can include re-establishing associations between an identified entity and others (block 450), for example by reiterating various procedures of the method 400. This can be triggered by a specific event (for example, a new query on the identified entity, an instance of fraud involving the entity) and/or may be performed periodically. Similarly, the entity's trust score may be re-calculated (block 455), as it may change as well. For example, as described in the Trust Applications, the entity's own activities often will impact its trust score. Additionally, however, newly-ascertained associations and/or new information about associated entities can also impact the trust score of the identified entity.

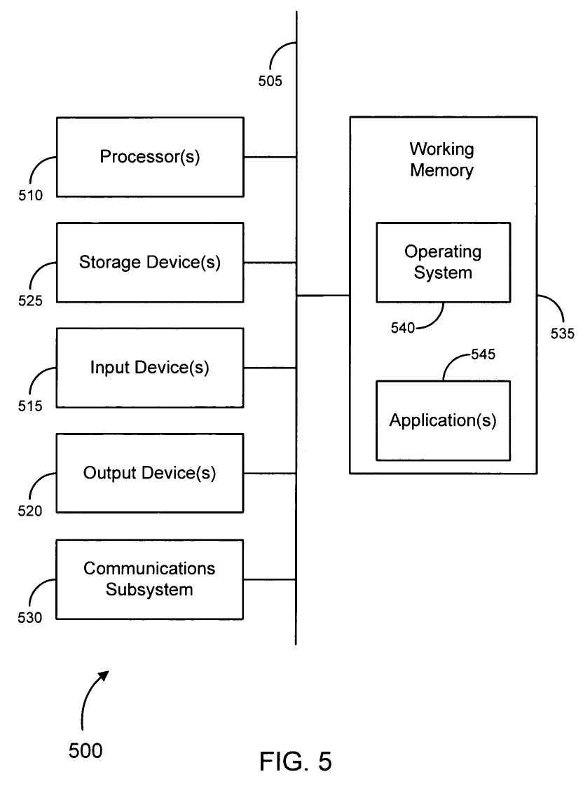

FIG. 5 provides a schematic illustration of one embodiment of a computer system 500 that can perform the methods of the invention and/or the functions of the computers described herein. It should be noted that FIG. 5 is meant only to provide a generalized illustration of various components, any or all of which may be utilized as appropriate. FIG. 5, therefore, broadly illustrates how individual system elements may be implemented in a relatively separated or relatively more integrated manner. The computer system 500 is shown comprising hardware elements that can electrically coupled via a bus 505 (or may otherwise be in communication, as appropriate). The hardware elements can include one or more processors 510, including without limitation one or more general-purpose processors and/or one or more special-purpose processors (such as digital signal processing chips, graphics acceleration chips, and/or the like); one or more input devices 515, which can include without limitation a mouse, a keyboard and/or the like; and one or more output devices 520, which can include without limitation a display device, a printer and/or the like.

The computer system 500 may further include (and/or be in communication with) one or more storage devices 525, which can comprise, without limitation, local and/or network accessible storage and/or can include, without limitation, a disk drive, a drive array, an optical storage device, solid-state storage device such as a random access memory (“RAM”) and/or a read-only memory (“ROM”), which can be programmable, flash-updateable and/or the like. The computer system 5 might also include a communications subsystem 530; which can include without limitation a modem, a network card (wireless or wired), an infra-red communication device, and/or the like), a wireless communication device and/or chipset (such as a Bluetooth™ device, an 802.11 device, a WiFi device, a WiMax device, cellular communication facilities, etc.). The communications system 530 may permit data to be exchanged with a network (such as the networks described above), and/or any other devices described herein. In many embodiments, the computer system 500 will further comprise a memory 535, which can include a RAM or ROM device, as described above.

The computer system 500 also can comprise software elements, shown as being currently located within a working memory 535, including an operating system 540 and/or other code 545, such as one or more application programs, which may comprise computer programs of the invention and/or may be designed to implement methods of the invention, as described herein. It will be apparent to those skilled in the art that substantial variations may be made in accordance with specific requirements. For example, customized hardware might also be used and/or particular elements might be implemented in hardware, software (including portable software, such as applets), or both. Further, connection to other computing devices such as network input/output devices may be employed.

While the invention has been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods of the invention are not limited to any particular structural and/or functional architecture but instead can be implemented on any suitable hardware, firmware and/or software configuration. Similarly, while various functionality is ascribed to certain system components, unless the context dictates otherwise, this functionality can be distributed among various other system components in accordance with different embodiments of the invention.

Moreover, while the procedures comprised in the methods and processes described herein are described in a particular order for ease of description, unless the context dictates otherwise, various procedures may be reordered, added, and/or omitted in accordance with various embodiments of the invention. Further, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary features, the various components and/or features described herein with respect to a particular embodiment can be substituted, added and/or subtracted from among other described embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A computer system for evaluating an Internet domain registration, the computer system comprising:
a processor;
a database comprising a plurality of records corresponding to a plurality of online entities, each record comprising information about one of the online entities; and
a set of instructions executable by the processor, the set of instructions comprising:
(a) instructions to identify a domain registration of interest, the domain registration comprising a data element comprising information related to the domain of interest;
(b) instructions to search the database for the data element to produce a search result comprising a set of one or more records, one of the set of one or more records corresponding to an online entity;
(c) instructions to associate the domain registration with the online entity;
(d) instructions to identify a second data element in the record corresponding to the online entity;
(e) instructions to search the database for the second data element to produce a search result comprising a second set of one or more records, one of the second set of the one or more records corresponding to a second online entity;
(f) instructions to associate the domain registration with the second online entity; and
(g) instructions to determine whether the domain registration is likely to be trustworthy, based upon information about the first and second online entities.

2. A computer program embodied on a computer readable medium, the computer program comprising a set of instructions executable by one or more computers, the set of instructions comprising:
instructions to maintain a database comprising a plurality of records corresponding to a plurality of online entities, each record comprising information about one of the online entities;
instructions to identify a domain registration of interest, the domain registration comprising a data element comprising information related to the domain of interest;
instructions to search the database for the data element to produce a search result comprising a set of one or more records, one of the set of one or more records corresponding to an online entity;
instructions to associate the domain registration with the online entity;
instructions to identify a second data element in the record corresponding to the online entity;
instructions to search the database for the second data element to produce a search result comprising a second set of one or more records, one of the second set of the one or more records corresponding to a second online entity;
instructions to associate the domain registration with the second online entity; and
instructions to determine whether the domain registration is likely to be trustworthy, based upon information about the first and second online entities.

3. A method of evaluating an Internet domain registration, the method comprising:
maintaining a database comprising a plurality of records corresponding to a plurality of online entities, each record comprising information about one of the online entities;
identifying a domain registration of interest, the domain registration comprising a data element comprising information related to the domain of interest;
searching the database for the data element to produce a search result comprising a set of one or more records, one of the set of one or more records corresponding to an online entity;
associating the domain registration with the online entity;
identifying a second data element in the record corresponding to the online entity;
searching the database for the second data element to produce a search result comprising a second set of one or more records, one of the second set of the one or more records corresponding to a second online entity;
associating the domain registration with the second online entity; and
based upon information about the first and second online entities, determining whether the domain registration is likely to be trustworthy.

4. A method as recited in claim 3, wherein the data element comprises information selected from the group consisting of: an email address, a physical address, a telephone number, a personal name, a corporate name and an IP address.

5. A method of identifying an online entity, the method comprising:
maintaining in a data store a set of data about a plurality of online entities, wherein the set of data comprises a plurality of data elements, each of the plurality of data elements being related to at least one of the plurality of online entities;
identifying with a computer a first of the plurality of online entities, based on at least part of the set of data;
identifying a first data group, the first data group comprising at least one data element associated with a first of the plurality of online entities;
identifying a second data group, the second data group comprising at least one data element associated with a second of the plurality of online entities;
determining that the first data group and the second data group each comprise at least one common data element; and
based on the at least one common data element, associating the first of the plurality of online entities with the second of the plurality of online entities.

6. A method of identifying an online entity as recited in claim 5, wherein associating the first of the plurality of online entities and the second of the plurality of online entities comprises identifying the first of the plurality of online entities and the second of the plurality of online entities as the same online entity.

7. A method of identifying an online entity as recited in claim 5, wherein associating the first of the plurality of online entities and the second of the plurality of online entities comprises creating a new database record comprising information about the first of the plurality of online entities and information about the second of the plurality of online entities.

8. A method of identifying an online entity as recited in claim 5, wherein the online entity is a person.

9. A method of identifying an online entity as recited in claim 5, wherein the online entity is an Internet domain.

10. A method of identifying an online entity as recited in claim 5, wherein the at least one common data element comprises data selected from the group consisting of a domain name, a hostname, an IP address, a network block, a personal name, a corporate name, an electronic mail address, a physical address and a telephone number.

11. A method of identifying an online entity as recited in claim 5, further comprising:
identifying a third data group, the third data group comprising at least one data element associated with a third of the plurality of online entities;
determining that the second data group and the third data group each comprise at least one common data element; and
based on the at least one common data element, associating the first of the plurality of online entities and the third of the plurality of online entities.

12. A method of identifying an online entity as recited in claim 5, further comprising:
assigning a trust score to the first of the plurality of online entities, based at least in part on information about the second of the plurality of online entities.

13. A method of identifying an online entity, the method comprising:
obtaining an identifier associated with the online entity;
maintaining a set of identifying data compiled from a plurality of data sources, wherein the set of identifying data comprises a plurality of data elements of disparate types;
correlating the plurality of data elements to ascertain a relationship between the plurality of data elements;
searching the set of identifying data to identify one of the plurality of data elements as being associated with the identifier; and
based on the relationship between the plurality of data elements, identifying the online entity.

14. A method as recited in claim 13, wherein the identifier comprises an identifier selected from a group consisting of a domain name, a hostname, an IP address, a network block, a personal name, a corporate name, an electronic mail address, a physical address and a telephone number.

15. A method as recited in claim 13, wherein the at least one of the plurality of data elements comprises information selected from a group consisting of registrar information, WHOIS information, network registration information, domain name service (“DNS”) information, Uniform Dispute Resolution Policy (“UDRP”) information, trademark information, corporate records information, public records information, information about past illicit activities and enabling party information.

16. A method as recited in claim 13, the method further comprising:
obtaining from a plurality of data sources a plurality of sets of information, each of the plurality of sets of information comprising information useful for identifying an online entity.

17. A computer system comprising one or more computers configured to perform the method recited in claim 13.

18. A computer software program comprising instructions executable by one or more computers to perform the method recited in claim 13.

19. A method of creating an identification database, the method comprising:
harvesting, with one or more computers, data about a plurality of online entities from a plurality of data sources;
storing the harvested data in at least one data store;
identifying with a computer an online entity from at least some of the harvested data;
searching the data store for additional information related to the online entity; and
associating the additional information with the online entity.

20. A method as recited in claim 19, wherein the harvested data comprises a plurality of data elements of disparate types.

21. A method as recited in claim 20, the method further comprising:
correlating the plurality of data elements to ascertain a relationship between the plurality of data elements.

22. A method as recited in claim 21, wherein associating the additional information with the online entity comprises associating the plurality of data elements with the online entity.

23. A method as recited in claim 19, further comprising:
creating in a second data store an association between the online entity and the additional information.

24. A method as recited in claim 19, further comprising:
determining that a second online entity is related to the online entity; and
associating the additional information with the second online entity.
